(19) United States
(12) Patent Application Publication
(10) Pub. No.: US 2019/0077567 A1
(43) Pub. Date: Mar. 14, 2019

(54) AIRBAG SEALING STRUCTURE AND METHOD

(71) Applicant: Guangdong Willing Technology Corporation, Huizhou (CN)

(72) Inventor: Jingnong Ye, Huizhou (CN)

(21) Appl. No.: 15/700,168

(22) Filed: Sep. 10, 2017

(51) Int. Cl. B65D 81/05; B65B 7/16; B29C 65/02; B29C 65/00

(52) U.S. Cl. CPC B65D 81/052; B65B 7/164; B29L 2022/027; B29C 66/43121; B29C 65/02

(57) ABSTRACT

An airbag sealing structure, including: an airbag body; at least one opening portion, configured on the airbag body; at least one passage portion, configured inside the airbag body and positioned at one side of the opening portion, a diameter of the passage portion being smaller than 2.9 millimeters; at least one accommodation space far away from the side of the opening portion and configured on the passage portion; and at least one blocking portion, configured inside the accommodation space and positioned at one side of the passage portion. Thereupon, a pneumatic pump nozzle may be inserted in the opening portion of the airbag body to fill air into the airbag body, air will then enter the accommodation space through the passage portion to inflate the accommodation space; when the accommodation space is saturated with air, the airbag body will seal the passage portion; thereafter, the passage portions are hot-sealed immediately.

### (a) TECHNICAL FIELD OF THE INVENTION

The present invention relates to an airbag sealing structure and method, and more particularly to an airbag sealing structure and method simple in operation, ideal in sealing effects and lower in production cost.

### (b) DESCRIPTION OF THE PRIOR ART

An airbag is an inflatable cushioning material used to pack items; air is filled in a sealed bag to inflate it to form a cushioning protection structure. Currently, airbags are now the world's most popular packaging materials because the characteristics thereof are conform to current environmental protection and effective warehouse space use appeals, and are more eye-appealing and protective for items compared to traditional packaging materials such that may international famous enterprises all use airbags for the packaging of merchandises. A related document Taiwan Patent No. 1297319, titled “air sealing body having strengthening airtight function”, being an air hermetically sealing body having a strengthening airtight function, which includes two outer films stacked vertically and two inner films between the two outer films an interval line is formed between the upper and lower sides of the two inner films by means of hot sealing, an air filling passage between the upper side and interval line of the two inner films, at least one air chamber between the lower side and interval line of the two outer films, at least one air entrance on a location of the interval line stuck to the two inner films, adapted to be in communication with the air filling passage and air chamber, and a cushioning room between the two outer films and inner films after hot sealing is carried out between the upper side of the two outer films and interval line. Whereby, the air in the cushioning room is used to push the inner films to seal the air filling passage when the air in the air chamber leaks out to the cushioning room, prevent the air from leaking out through the air filling passage.

However, the above air hermetically sealing body having a strengthening airtight function has the following disadvantages to be overcome upon use and manufacturing:
1. the inner films must be configured inside the outer films, and the air filling passage sealing effect can then be achieved upon the manufacturing of the above air hermetically sealing body having a strengthening airtight function, resulting in a higher production cost; and
2. It has slightly inadequate strength to seal the air filling passage only depending on a check structure of the inner films such that the air in the air filling passage will leak out through inner films after a period of time, and the air hermetically selling body will also leak upon temperature change, resulting in the unsatisfied performance of the air bag to protect items.

### SUMMARY OF THE INVENTION

The main object of the present invention is to provide an airbag sealing structure and method, using the designs of the minute passage portions and blocking portion to reduce the product cost thereof, and make airbags more simply.

To achieve the object mentioned above, the present invention proposes an airbag sealing structure, including: an airbag body; at least one opening portion, configured on the airbag body; at least one passage portion, configured inside the airbag body and positioned at one side of the opening portion, a diameter of the passage portion being smaller than 2.9 millimeters; at least one accommodation space far away from the side of the opening portion and configured on the passage portion; and at least one blocking portion, configured inside the accommodation space and positioned at one side of the passage portion. Thereupon, a pneumatic pump nozzle may be inserted in the opening portion of the airbag body to fill air into the airbag body, air will then enter the accommodation space through the passage portion to inflate the accommodation space; when the accommodation space is saturated with air, the airbag body will become tense and taut to press the blocking portion to seal the passage portion; thereafter, the passage portions are hot-sealed within 1.5 seconds after the passage portions are locked so that the airbag body can be filled with air almost completely, allowing the operation to be very simple without needing the check valve structure of the inner films used in conventional airbags so as to reduce the production cost.

### BRIEF DESCRIPTION OF THE DRAWINGS

FIG. 1 is a schematic view of a preferred embodiment of the present invention;

FIG. 2 is a flow chart of the embodiment of the present invention;

FIGS. 3 to 6 respectively are a schematically perspective view of the embodiment of the present invention, a sealing process being in action step by step;

FIG. 7 is a schematic view of another preferred embodiment of the present invention; and

FIG. 8 is a schematic view of still another preferred embodiment of the present invention.

### DETAILED DESCRIPTION OF THE PREFERRED EMBODIMENTS

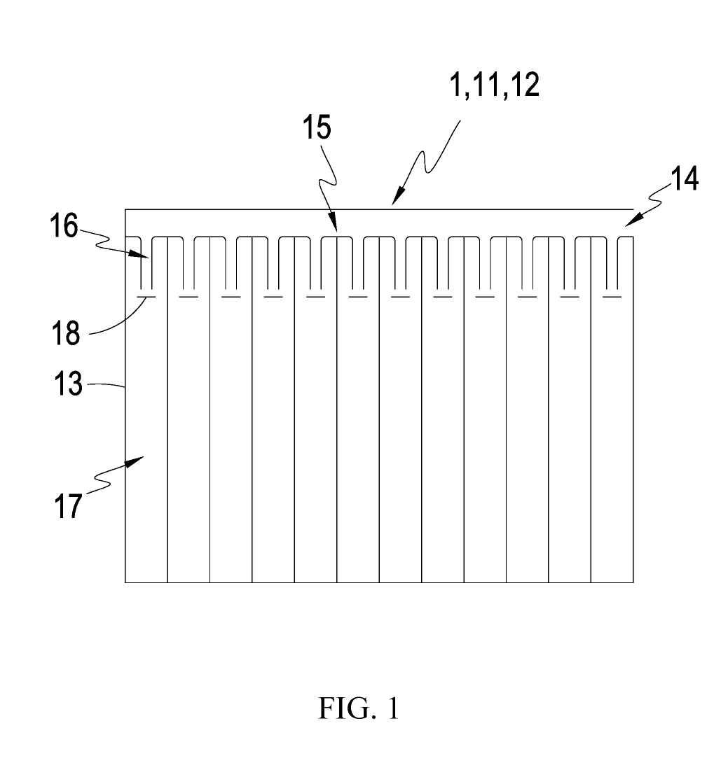

Referring to FIG. 1, an airbag sealing structure of the present invention, in a preferred embodiment, includes: an airbag body 1, including at least one first substrate 11 and at least one second substrate 12 configured on the first substrate 11, and at least one connection portion 13 configured on the first substrate 11 and second substrate 12; and at least one opening portion 14 configured on the airbag body 1, at least one passage portion 16 positioned at one side of the opening portion 14 being configured inside the airbag body 1, where the passage portion 16 is smaller than 2.9 mm in diameter, at least one accommodation space 17 configured on one side of the passage portion 16 far away from the opening portion 14, at least one blocking portion 18 positioned at one side of the passage portion 16 being formed inside the accommodation space 17, and at least one air entrance passage 15 formed between the opening portion 14 and passage portion 16.

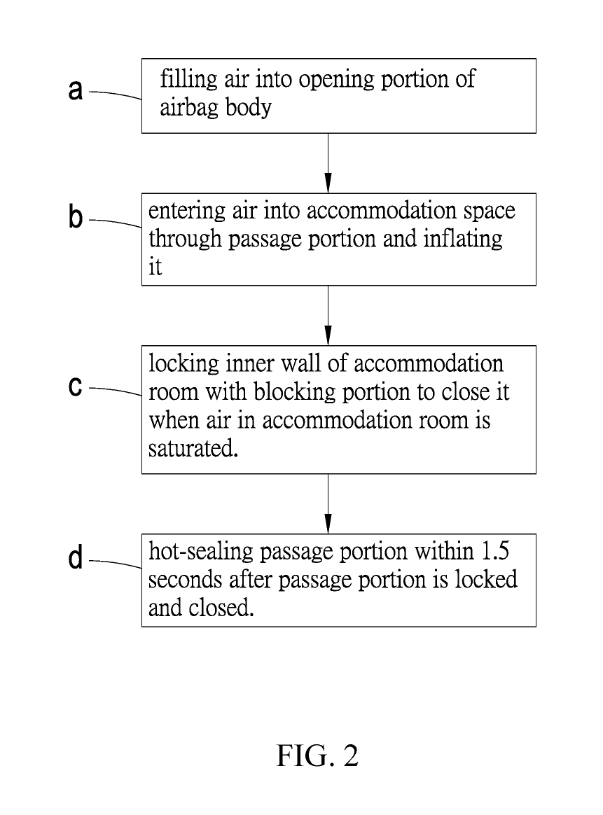

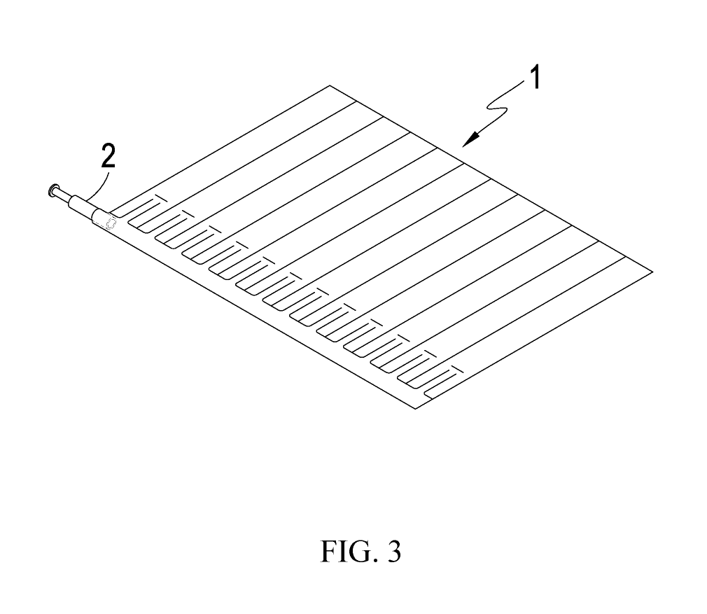

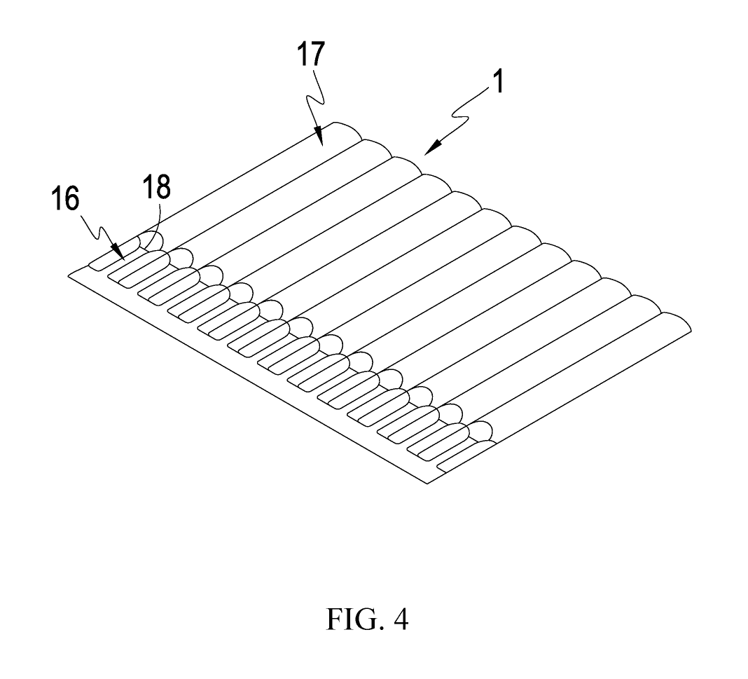

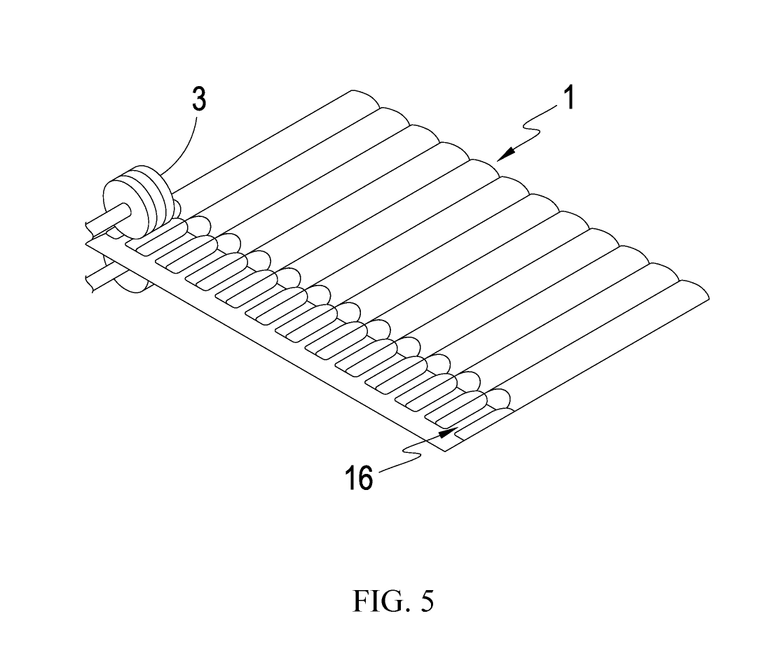

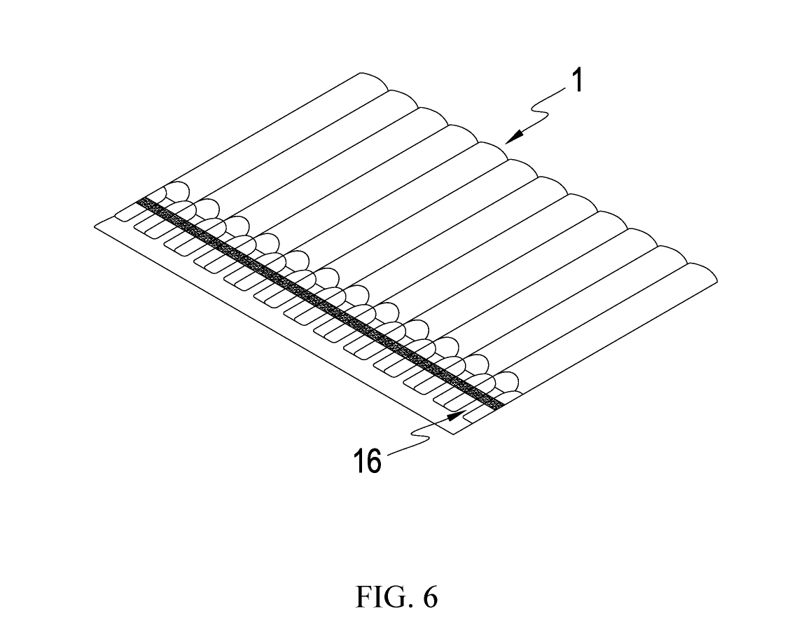

Referring to FIGS. 1 to 6, a method for filling air in and sealing the airbag body 1 of the present invention has the following steps:

(a) filling air into the opening portion 14 of the airbag body 1;

(b) entering air into the accommodation space 17 to inflate it through the passage portion 16;

(c) sealing the passage portion 16 by locking the inner wall of the accommodation space 17 with the blocking portion 18 to block air from entering the accommodation space 17 when the air in the accommodation space 17 is saturated; and

(d) hot-sealing the passage portion 16 within 1.5 seconds after the passage portion 16 is locked.

In the embodiment, the airbag body 1 is formed by connecting the first substrate 11 with second substrate 12, where the first and second substrates 11, 12 respectively are a hot melt material such as nylon, polyethylene terephthalate (PET), high density polyethylene (PE) or plastics; the first and second substrates 11, 12 are in connection with each other to form the connection portion 13, and the airbag body 1 is formed into an accommodation space 17 for the accommodation of air. Furthermore, the accommodation space 17 has the passage portion 16, which is a micro airway having a diameter below 2.9 millimeters. In addition, the inside of the accommodation space 17 is formed with a blocking portion 18 adapted to block the passage portion 16, which is also formed by means of hot melting, and the air entrance passage 15 is formed between the passage portion 16 and the opening portion 14, allowing only one single opening portion 14 can be in communication with a plurality of passage portions 16. Whereby, a pneumatic pump nozzle 2 is inserted in the opening portion 14 of the airbag body 1 to fill air into the airbag body 1 when the air-filling and sealing of the airbag body 1 are carried out, air will then enter the accommodation space 17 through the passage portion 16 to inflate the accommodation space 17, and the next accommodation space 17 will then be started to fill with air when the pressure in the air entrance passage 15 is equal to the one in the accommodation space 17, which will not stopped until all the accommodation spaces 17 are filled with air. When the accommodation space 17 is saturated with air, the material of the airbag body 1 is pulled and dragged to press the blocking portion 18 to lock the inner wall of the accommodation space 17, allowing the blocking portion 18 to lock the passage portion 17 and the passage portion 16 temporarily. Thereafter, a hot-sealing roll 3 is used to seal the passage portions within 1.5 seconds after the passage portions 16 are locked. Here, the passage portion 16 is very minute in diameter, allowing the blocking portion 18 to lock the passage portion 16 very stably, and the airbag body 1 to be filled with air completely. Therefore, the operation of the present invention is very simple, and the production cost can be saved compared to conventional airbags.

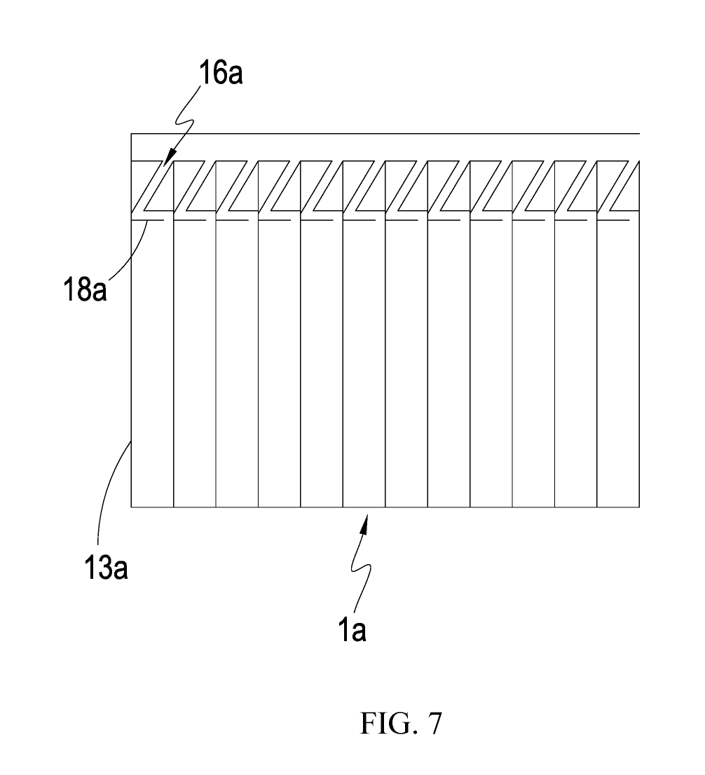

Referring to FIG. 7, the passage portion 16a, in another preferred embodiment, is in an inclined pattern, and one end of the blocking portion 18a is in connection with the connection portion 13a, allowing the blocking portion 18a to lock the passage portion 16a more stably when the air filled in the airbag body 1a is saturated. The making of the air bag in the present embodiment is similar to the embodiment mentioned above; the detailed thereof is here omitted.

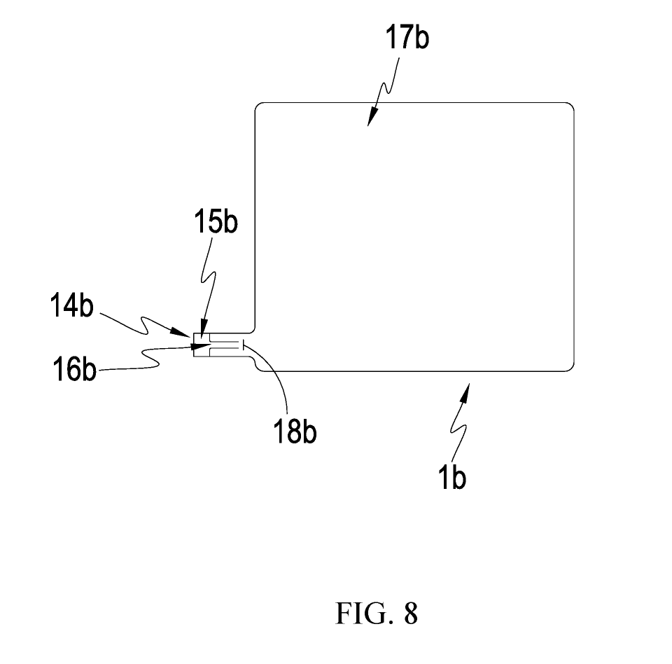

Referring to FIG. 8, the airbag body 1b, in a still another preferred embodiment, only has one accommodation space 17b, allowing the entire structure of the airbag body 1b to be simpler, and the airbag body 1b is only configured with one opening portion 14b. In addition, the passage portion 16b is configured at one side of the opening portion 14b, at least one air entrance passage 15b is configured between the opening portion 14b and passage portion 16b, and the blocking portion 18b positioned on one side of the passage portion 16b is formed inside the airbag body 1b. When the pressure in the air entrance passage 15b is in equilibrium with the pressure in the accommodation space 17b, the blocking portion 18b will lock the passage portion 16b temporarily. The making of the airbag in the present embodiment is similar to the embodiments mentioned above; the detailed thereof is here omitted.

From the description mentioned above, it is obvious that the present invention has the following advantages; the designs of the minute passage portion 16 and blocking portion 18 allow the production cost thereof to be reduced, and an airbag to be made more simply.

I claim:

1. An airbag sealing structure, comprising:
an airbag body;
at least one opening portion, configured on said airbag body;
at least one passage portion, configured inside said airbag body and positioned at one side of said opening portion, a diameter of said passage portion being smaller than 2.9 millimeters;
at least one accommodation space far away from said side of said opening portion and configured on said passage portion; and
at least one blocking portion, configured inside said accommodation space and positioned at one side of said passage portion.

2. The structure according to claim 1, wherein at least one air entrance passage is configured between said opening portion and passage portion.

3. The structure according to claim 1, wherein said airbag body comprises at least one first substrate and at least one second substrate configured on said first substrate.

4. The structure according to claim 3, wherein at least one connection portion is configured on said first and second substrates.

5. The structure according to claim 1, wherein said airbag structure is a hot melt material.

6. An airbag sealing method, comprising:
(a) filling air into an opening portion of an airbag body;
(b) inflating an accommodation space by entering air into said accommodation space through a passage portion;
(c) locking an inner wall of said accommodation space with a blocking portion to close said passage portion when said air for inflation in said accommodation space is saturated; and
(d) hot-sealing said passage portion within 1.5 seconds after said passage portion is locked and closed.

7. The method according to claim 6, wherein at least one air entrance passage is configured between said opening portion and passage portion.

8. The method according to claim 6, wherein said airbag body comprises at least one firs substrate and at least one second substrate configured on said first substrate.

9. The method according to claim 8, wherein at least one connection portion is configured on said first and second substrates.

10. The method according to claim 6, wherein said airbag structure is a hot melt material.
